(19) United States
(12) Patent Application Publication
(10) Pub. No.: US 2022/0287370 A1
(43) Pub. Date: Sep. 15, 2022

(54) ELECTRONIC ATOMIZATION DEVICE, HEATING ELEMENT THEREOF, AND HEATING STRUCTURE

(71) Applicant: SHENZHEN SMOORE TECHNOLOGY LIMITED, Shenzhen (CN)

(72) Inventor: Wenli DU, Shenzhen (CN)

(21) Appl. No.: 17/826,579

(22) Filed: May 27, 2022

Related U.S. Application Data
(63) Continuation of application No. PCT/CN2020/118830, filed on Sep. 29, 2020.

(30) Foreign Application Priority Data
Dec. 2, 2019 (CN) 201922155331.3

(51) Int. Cl. A24F 40/465; H05B 6/10; A24F 40/20; A24F 40/485

(52) U.S. Cl. CPC A24F 40/465; H05B 6/105; A24F 40/20; A24F 40/485

(57) ABSTRACT

A heating structure for a cigarette includes: a hollow and tubular heating body insertable into the cigarette from a top end, a top end of the heating body including an opening and a side wall of the heating body including at least one gap extending from the opening on the top end to a bottom end of the heating body.

### CROSS-REFERENCE TO PRIOR APPLICATION

This application is a continuation of International Patent Application No. PCT/CN2020/118830, filed on Sep. 29, 2020, which claims priority to Chinese Patent Application No. CN 201922155331.3, filed on Dec. 2, 2019. The entire disclosure of both applications is hereby incorporated by reference herein.

### FIELD

The present invention relates to a vaporization apparatus, and more specifically, to an electronic vaporization apparatus, and a heating assembly and a heating structure thereof.

### BACKGROUND

Heat not burn (HNB) cigarette baking mainly includes resistance heating and electromagnetic heating. In an existing electromagnetic induction method, a cigarette is generally accommodated by using a metal tube, and induction coils are disposed outside the metal tube and external heating is performed to the cigarette after an induced current is generated; or a metal sheet is inserted into the cigarette, and the metal sheet heats a center of the cigarette after generating an induced current.

Both the foregoing two manners have a problem of non-uniform heating, that is, tobacco has a position that is relatively far from the metal tube or the metal sheet, and a temperature of the position is relatively low.

### SUMMARY

In an embodiment, the present invention provides a heating structure for a cigarette, comprising: a hollow and tubular heating body insertable into the cigarette from a top end, a top end of the heating body comprising an opening and a side wall of the heating body comprising at least one gap extending from the opening on the top end to a bottom end of the heating body.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a three-dimensional schematic structural diagram of an electronic vaporization apparatus according to some embodiments of the present invention;

FIG. 2 is a partial schematic structural diagram of the electronic vaporization apparatus shown in FIG. 1;

FIG. 3 is a longitudinal cross-sectional view of the electronic vaporization apparatus shown in FIG. 1;

FIG. 4 is a partial schematic structural diagram of a heating assembly of the electronic vaporization apparatus shown in FIG. 2;

FIG. 5 is a three-dimensional schematic structural diagram of a fixing sleeve of the heating assembly shown in FIG. 4; and

FIG. 6 is a three-dimensional schematic structural diagram of a heating structure of the heating assembly shown in FIG. 4.

### DETAILED DESCRIPTION

In an embodiment, the present invention provides an improved electronic vaporization apparatus, and a heating assembly and a heating structure thereof.

In an embodiment, the present invention provides a heating structure, including a hollow and tubular heating body inserted into a cigarette, where a top end of the heating body is provided with an opening; and a side wall of the heating body is provided with at least one gap extending from the opening on the top end of the heating body to a bottom end of the heating body.

Preferably, the at least one gap includes three gaps; and

the heating body includes three heating portions formed through segmentation by at least two gaps and connected to each other.

Preferably, the heating portion is in a shape of an arc sheet.

Preferably, the heating body further includes a connection portion located at the bottom end and connecting the three heating portions.

Preferably, a width of the gap is set to be increasingly large in a direction away from the connection portion; or

a width of the gap is set to be increasingly small in a direction away from the connection portion.

Preferably, widths of the gaps in an axial direction of the heating body are consistent.

Preferably, an insertion portion inserted into the cigarette is disposed on one end of the heating portion away from the connection portion; and

the insertion portion is a spire structure.

Preferably, a diameter of the heating body is less than a diameter of the cigarette.

Preferably, one gap in the at least one gap runs through the top end and the bottom end of the heating body.

The present invention further constructs a heating assembly, including a fixing sleeve configured to fix a cigarette, the heating structure described in the present invention disposed in the fixing sleeve to be inserted into the cigarette, and an electromagnetic induction coil sleeved on a periphery of the fixing sleeve to generate electromagnetic induction in a powered-on state to enable the heating structure to generate heat.

Preferably, a diameter of a heating body of the heating structure is less than an inner diameter of the fixing sleeve and less than a diameter of the cigarette; and/or

a heating portion of the heating structure is inserted into the cigarette in an axial direction; and a length of the heating portion is greater than or equal to one half length of the fixing sleeve, to extend toward a midpoint of the cigarette.

Preferably, at least one air intake slot is disposed on an inner side wall of the fixing sleeve; and

the air intake slot is disposed extending in a longitudinal direction of the inner side wall of the fixing sleeve.

Preferably, there are a plurality of air intake slots, and the plurality of air intake slots are disposed at intervals in a circumferential direction of the fixing sleeve.

Preferably, the fixing sleeve includes a coil mounting portion for the electromagnetic induction coil to encircle and a positioning portion disposed on one end of the coil mounting portion; and

an outer diameter of the coil mounting portion is less than an outer diameter of the positioning portion.

Preferably, a thermal insulation sleeve is disposed between the fixing sleeve and the electromagnetic induction coil.

The present invention further constructs an electronic vaporization apparatus, including a housing, the heating assembly according to the present invention disposed in the housing, a power supply component disposed in the housing and electrically connected to the heating assembly, and a control circuit disposed in the housing and connected to the heating assembly and the power supply component.

Beneficial Effects:

By implementing the electronic vaporization apparatus, the heating assembly and the heating structure thereof provided in the present invention, the following beneficial effects may be caused: In the heating structure, a heating body is set to be hollow and tubular, and at least one gap extending from an opening on a top end of the heating body to a bottom end of the heating body is disposed on a side wall of the heating body. Therefore, the elasticity of the heating body is enhanced to facilitate the heating body to be inserted into a cigarette, so that the cigarette is heated in a more uniform way, thereby improving the heating uniformity and improving the heating efficiency.

The heating assembly has advantages such as uniformly heating and high heating efficiency.

The electronic vaporization apparatus has advantages such as uniformly heating and high heating efficiency.

In order to have a clearer understanding of the technical features, the objectives, and the effects of the present invention, specific implementations of the present invention are now illustrated in detail with reference to the accompanying drawings.

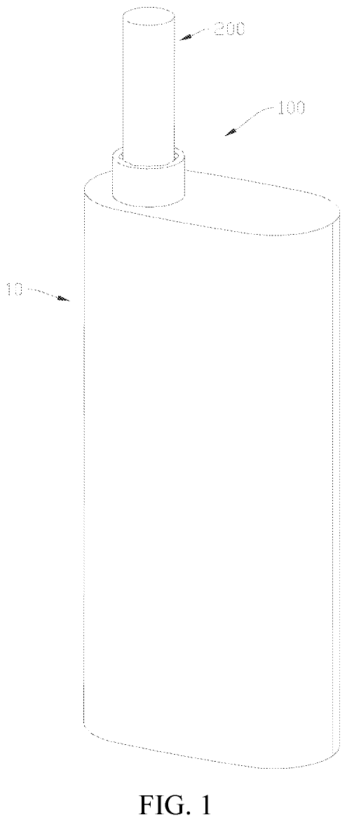

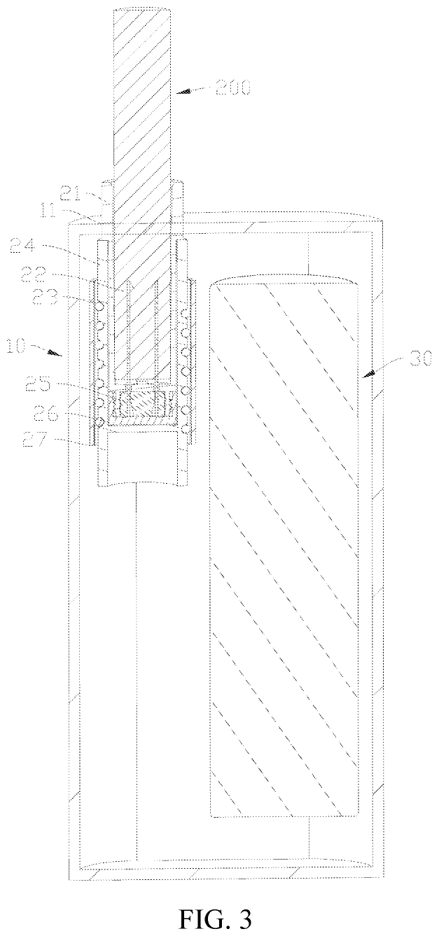

FIG. 1 to FIG. 3 show some exemplary embodiments of an electronic vaporization apparatus of the present invention. The electronic vaporization apparatus 100 is configured to heat a cigarette 200 and vapor the cigarette 200 without burning. The electronic vaporization apparatus has advantages such as uniformly heating and high heating efficiency.

As shown in FIG. 1 to FIG. 3, further in some embodiments, the electronic vaporization apparatus 100 includes a housing 10, a heating assembly 20, a power supply component 30, and a control circuit 40. The housing 10 is configured to accommodate the heating assembly 20, the power supply component 30, and the control circuit 40. The heating assembly 20 is disposed in the housing 10 and is configured to heat the cigarette 200. The power supply component 30 is electrically connected to the heating assembly 20 and supplies power to the heating assembly 20. The control circuit 40 is disposed in the housing 10 and is connected to the heating assembly 20 and the power supply component 30 to control heating of the heating assembly 20.

Further, in some embodiments, the housing 10 is in a shape similar to a cuboid and a cross section thereof is in a shape similar to an ellipse. An inner side of the housing 10 is a hollow structure to form an accommodation cavity to accommodate the heating assembly 20, the power supply component 30, and the control circuit 40. A through hole 11 is further disposed on a top wall of the housing 10, and the through hole 11 facilitates to fix the heating assembly 20 to further facilitate mounting of the cigarette 200.

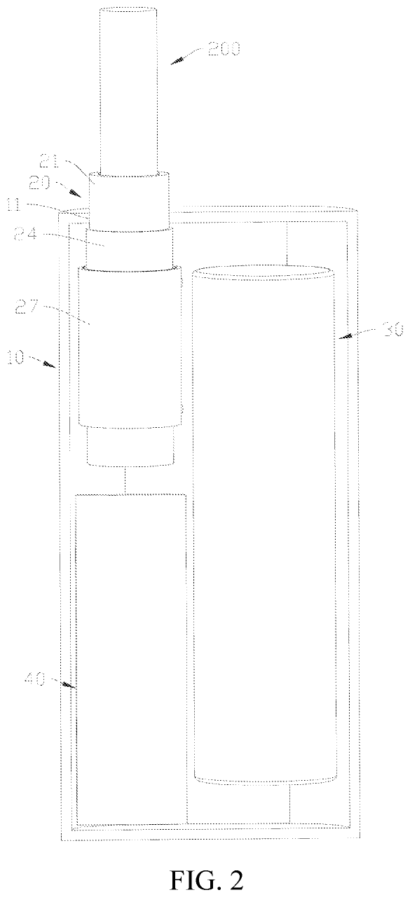

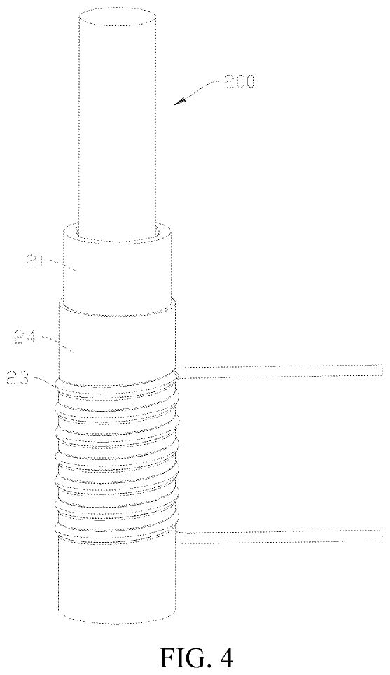

As shown in FIG. 2 to FIG. 6, further in some embodiments, the heating assembly 20 includes a fixing sleeve 21, a heating structure, and an electromagnetic induction coil 23. The fixing sleeve 21 runs through the housing 10, and one end of the fixing sleeve is disposed running through the through hole 11 on the top wall of the housing 10 to be fixed on the through hole 11. The heating structure is disposed in the fixing sleeve 21 and inserted into the cigarette 200, and heats tobaccos in the cigarette 200 by generating heat to vapor the tobaccos. The electromagnetic induction coil 23 is sleeved on a periphery of the fixing sleeve 21 and generates electromagnetic induction in a powered-on state to enable the heating structure to generate heat to further heat the cigarette 200.

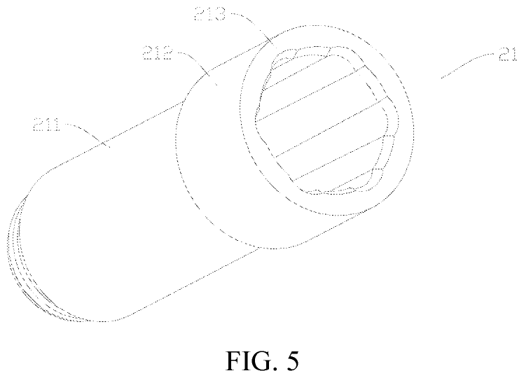

As shown in FIG. 5, further in some embodiments, the fixing sleeve 21 is in a shape of a tube and is a hollow structure. An inner diameter of the fixing sleeve is equal to an outer diameter of the cigarette 200, and the fixing sleeve is at least sleeved on a part of the cigarette 200 to fix the cigarette 200. The fixing sleeve 21 is disposed running through the through hole 11 on the top wall of the housing 10, to be connected and fixed to the housing 10 through cooperation with the through hole 11. In some embodiments, the fixing sleeve 21 includes a coil mounting portion 211 and a positioning portion 212. The coil mounting portion 211 is configured for the electromagnetic induction coil 23 to encircle and is in a shape of a column. An outer diameter of the coil mounting portion is less than or equal to an inner diameter of the through hole 11 on the top wall of the housing 10, and the coil mounting portion runs through the through hole 11 to the inner side of the housing 10. The positioning portion 212 is disposed on one end of the coil mounting portion 211 and is in a shape of a column. An outer diameter of the positioning portion is greater than the outer diameter of the coil mounting portion 211, the outer diameter of the positioning portion is greater than the inner diameter of the through hole 11 on the top wall of the housing 10, and the positioning portion is disposed on an outer side of the housing 10 to further perform positioning through cooperation with the housing 10.

Further, in some embodiments, at least one air intake slot 213 is disposed on an inner side wall of the fixing sleeve 21. In some embodiments, there may be a plurality of air intake slots 213, and the plurality of air intake slots 213 are disposed at intervals in a circumferential direction of the fixing sleeve 21. It may be understood that, in some other embodiments, the quantity of the air intake slots 213 is not limited thereto and may alternatively be one. The air intake slot 213 is disposed extending in a longitudinal direction of the inner side wall of the fixing sleeve 21 and may be a strip-shaped slot. The air intake slot is formed through concaving of an inner surface of the fixing sleeve 21 and is disposed in parallel to a central axis of the fixing sleeve of the cigarette 200, which is configured to form an airflow channel for air to enter the fixing sleeve of the cigarette 200, thereby facilitating to transmit out vapor generated by heating the cigarette 200.

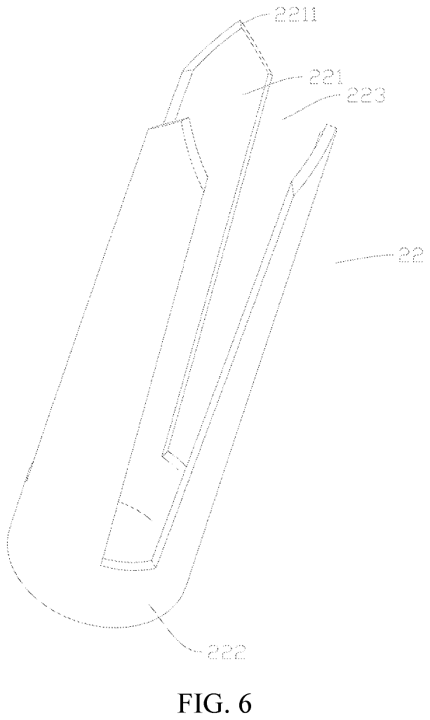

As shown in FIG. 6, further in some embodiments, the heating structure includes a heating body 22. The heating body 22 is a hollow structure and is in a shape of a tube, and is provided with an opening on both a top end and a bottom end. Specifically, in some embodiments, the heating body is in a shape of a circular tube. A diameter of the heating body 22 is less than a diameter of the cigarette 200 and is less than an inner diameter of the coil mounting portion 211. The heating body is inserted into the cigarette 200 and generates heat when the electromagnetic induction cigarette 23 is in a powered-on state to heat the tobaccos in the cigarette 200. The heating body 22 is set to be in a shape of a tube to transfer heat to a center and an outer side, so that a baking area is wide and the utilization of tobaccos is improved.

Further, in some embodiments, the heating body 22 includes a heating portion 221, a connection portion 222, and a gap 223. In some embodiments, the gap 223 is disposed on a side wall of the heating body 22 and is disposed extending from an opening on a top end of the heating body 22 to a bottom end of the heating body. There may be one gap 223 or may be a plurality of gaps. In some embodiments, there may be at least two gaps; and the at least two gaps 223 segment the heating body to form at least two heating portions 221 connected to each other. Optionally, there may be three gaps 223, and the three gaps 223 are disposed at intervals to form three heating portions 221. By disposing the gap 223, the heating body 22 may include certain elasticity, which facilitates the heating body to be inserted into the cigarette 200. The connection portion 222 is disposed at a bottom end of the heating portion 221 and is connected to the at least two heating portions 221 respectively, so that the heating portion 221 is still a whole.

Further, in some embodiments, each heating portion 221 may be in a shape of an arc sheet and is inserted into the cigarette 200 in an axial direction. The heating portion is disposed coaxially with the cigarette 200, and a length of the heating portion is greater than or equal to one half length of the fixing sleeve 21 and further extends toward a midpoint of the cigarette 200, so that the cigarette 200 is heated in a more uniform way during heating. In some embodiments, an insertion portion 2211 is disposed on one end of the heating portion 221 away from the connection portion 222; and the insertion portion 2211 is inserted into the cigarette 200, to further facilitate the heating portion 221 to be inserted into the cigarette 200. The insertion portion 2211 is a spire structure. Specifically, in some embodiments, the insertion portion 2211 is in a shape of a triangle, a cone, or a wedge.

Further, in some embodiments, the connection portion 222 may be in a shape of a circular ring, disposed coaxially with the heating portion 221, and integrally formed with the heating portion 221. Optionally, the connection portion may be integrally formed with the heating portion 221 through die casting. A peripheral wall of the connection portion 222 may be a smooth curved surface. It may be understood that, in some other embodiments, the peripheral wall of the connection portion 222 is not limited to a smooth curved surface, and a mounting hole or a clamping slot is disposed on the connection portion, to further facilitate clamping and fixing with the cigarette 200.

It may be understood that, in some other embodiments, the shape of the connection portion 222 is not limited to a circular ring. In some other embodiments, one gap in the gaps 223 extends from the opening on the top end of the heating body 22 to the opening on the bottom end, thereby running through the bottom end and the top end of the heating body 22. As a result, the connection portion 222 is segmented into an arc-shaped structure, to further facilitate clamping and fixing with the cigarette 200.

Further, in some embodiments, the gaps 223 respectively extend from the end of the heating body 22 provided with the insertion portion 2211 to one end of the connection portion 222 close to the insertion portion 2211; and widths of the gaps 223 in an axial direction of the heating body 22 are consistent. It may be understood that, in some other embodiments, the width of the gap 223 is set to be increasingly large in a direction away from the connection portion 222, or the width of the gap 223 is set to be increasingly small in a direction away from the connection portion 222.

Further, in some embodiments, the electromagnetic induction coil 23 is disposed around the coil mounting portion 211, so that the structure is more compact. In some embodiments, the electromagnetic induction coil 23 may be an enameled wire, two ends of the electromagnetic induction coil 23 are respectively connected to the control circuit 40, and the electromagnetic induction coil 23 generates an electromagnetic field in a powered-on state, to further enable the heating body 22 to generate heat.

Further, in some embodiments, the heating assembly 20 further includes a thermal insulation sleeve 24; and the thermal insulation sleeve 24 is disposed between the fixing sleeve 21 and the electromagnetic induction coil 23. Optionally, the thermal insulation sleeve 24 is sleeved on the coil mounting portion 211, and the electromagnetic induction coil 233 is disposed around the thermal insulation sleeve 24. The thermal insulation sleeve 24 is made of heat insulation foam or silica gel.

Further, in some embodiments, the heating assembly 20 further includes a silica gel body 25 disposed at a lower portion of the fixing sleeve 21 to fix the heating body 22. The silica gel body 25 is filled in a lower portion space of the fixing sleeve 21 and is in a shape of a column. The connection portion 222 of the heating body 22 is buried in the silica gel body 25.

Further, in some embodiments, the heating assembly 20 further includes a positioning sleeve 26; and the positioning sleeve 26 is sleeved on the lower portion of the fixing sleeve 21, to prevent the silica gel body 25 from falling off. The positioning sleeve 26 and the fixing sleeve 21 are connected through interference fitting. Certainly, it may be understood that, in some other embodiments, the positioning sleeve may alternatively be connected to the fixing sleeve 21 through a disposed clamping structure.

Further, in some embodiments, the heating assembly 20 further includes a protecting sleeve 27; and a length of the protecting sleeve 27 is equal to a length of the coil mounting portion 211, and the protecting sleeve is sleeved on a periphery of the electromagnetic induction coil 23, to protect the electromagnetic induction coil 23. The protecting sleeve 27 may be an insulating protecting sleeve to play a role of insulating protection.

As shown in FIG. 2, further in some embodiments, the power supply component 30 is disposed on one side of the heating assembly 20 and is electrically connected to the electromagnetic induction coil 23. The power supply component may be a battery, and optionally, a 18650 lithium battery. It may be understood that, in some other embodiments, the power supply component is not limited to a 18650 lithium battery.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating structure for a cigarette, comprising:
a hollow and tubular heating body insertable into the cigarette from a top end, a top end of the heating body comprising an opening and a side wall of the heating body comprising at least one gap extending from the opening on the top end to a bottom end of the heating body.

2. The heating structure of claim 1, wherein the at least one gap comprises three gaps, and
wherein the heating body comprises three heating portions formed through segmentation by at least two gaps and connected to each other.

3. The heating structure of claim 2, wherein each heating portion is in a shape of an arc sheet.

4. The heating structure of claim 2, wherein the heating body comprises a connection portion located at the bottom end and connecting the three heating portions.

5. The heating structure of claim 3, wherein a width of each gap is increasingly larger in a direction away from the connection portion, or
wherein a width of each gap is increasingly smaller in a direction away from the connection portion.

6. The heating structure of claim 2, wherein widths of the three gaps in an axial direction of the heating body are consistent.

7. The heating structure of claim 4, wherein an insertion portion insertable into the cigarette is disposed on one end of the heating portion away from the connection portion, and
wherein the insertion portion comprises a spire structure.

8. The heating structure of claim 1, wherein a diameter of the heating body is less than a diameter of the cigarette.

9. The heating structure of claim 1, wherein one gap of the at least one gap runs through the bottom end and the top end of the heating body.

10. A heating assembly, comprising:
a fixing sleeve configured to fix a cigarette;
the heating structure of claim 1, the heating structure being disposed in the fixing sleeve; and
an electromagnetic induction coil sleeved on a periphery of the fixing sleeve, the electromagnetic induction coil being configured to generate electromagnetic induction in a powered-on state so as to enable the heating structure to generate heat.

11. The heating assembly of claim 10, wherein a diameter of a heating body of the heating structure is less than an inner diameter of the fixing sleeve and less than a diameter of the cigarette, and/or
wherein a heating portion of the heating structure is insertable into the cigarette in an axial direction, and a length of the heating portion is greater than or equal to one half a length of the fixing sleeve, to extend toward a midpoint of the cigarette.

12. The heating assembly of claim 10, wherein at least one air intake slot is disposed on an inner side wall of the fixing sleeve, and
wherein the air intake slot extends in a longitudinal direction of the inner side wall.

13. The heating assembly of claim 12, wherein the at least one air intake slot comprises a plurality of air intake slots, and
wherein the plurality of air intake slots are disposed at intervals in a circumferential direction of the fixing sleeve.

14. The heating assembly of claim 10, wherein the fixing sleeve comprises a coil mounting portion for the electromagnetic induction coil to encircle and a positioning portion disposed on one end of the coil mounting portion, and
wherein an outer diameter of the coil mounting portion is less than an outer diameter of the positioning portion.

15. The heating assembly of claim 10, wherein a thermal insulation sleeve is disposed between the fixing sleeve and the electromagnetic induction coil.

16. An electronic vaporization apparatus, comprising:
a housing;
the heating assembly of claim 10, the heading assembly being disposed in the housing;
a power supply component disposed in the housing and electrically connected to the heating assembly; and
a control circuit disposed in the housing and connected to the heating assembly and the power supply component.
